(19) United States
(12) Patent Application Publication
(10) Pub. No.: US 2005/0265599 A1
(43) Pub. Date: Dec. 1, 2005

(54) Methods and devices for controlling image contrast

(75) Inventors: Ling-Shiou Huang, Hsinhua (TW); Lin-Kai Bu, Hsinhua (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Himax Technologies, Inc.

(21) Appl. No.: 11/046,647

(22) Filed: Jan. 28, 2005

(30) Foreign Application Priority Data
May 26, 2004 (TW) 93114912

(51) Int. Cl. G06K 9/00; G06K 9/40

(52) U.S. Cl. 382/169; 382/274

(57) ABSTRACT

A method for controlling the contrast of an image is provided. The method comprising the steps of: providing display data of the frame, wherein the display data of the frame corresponds to a plurality of pixels; obtaining a gray-level value of at least one pixel according to the display data of the frame; calculating a probability function of at least one gray-level value in a predetermined range; and determining adjustment of the at least one gray-level value in the predetermined range according to the probability function.

### BACKGROUND

The invention relates to methods and devices for controlling image contrast, and in particular to methods and devices for dynamically adjusting image contrast.

In display devices, image contrast can be adjusted to change the relative degree of image color. According to general contrast adjustment methods, each gray-level value GL of one image is transferred through a transfer curve, whose slope is 0 to 2, to a corresponding new gray-level value GL′. Based on a transfer curve whose slope is 1, a conventional transformation of the gray-level values has three conditions. FIG. 1 shows a transfer curve whose slope is 1. As shown in FIG. 1, the transfer curve TC represents the relationship between gray-level values GL and corresponding new gray-level values GL′. According to the transfer curve TC of FIG. 1, each gray-level value GL is equal to the corresponding gray-level value GL′, that is, the contrast of the image is invariable, and the entire brightness thereof is also constant.

FIG. 2 shows a transfer curve whose slope is larger than 1. Since the slope of the transfer curve TC is larger than 1, each gray-level value GL is increased to the corresponding gray-level value GL′. Thus, the contrast of the image is raised, and the entire brightness thereof increased. The image however is not displayed correctly due to excessively increased brightness. FIG. 3 shows a transfer curve whose slope is smaller than 1. Since the slope of the transfer curve TC is smaller than 1, a gray-level value GL is decreased to the corresponding gray-level value GL′. Thus, the contrast of the image is lowered, and the overall brightness thereof is reduced. The image however is not displayed correctly due to excessively reduced brightness.

According to conventional contrast adjustment methods, the histogram distribution of gray-level values of an image is not considered, and all gray-level values are transferred through a fixed transfer curve. Although the contrast of the image can be adjusted, the overall brightness thereof is changed undesirably. Thus, during continuous image display, brightness of the image is unstable, resulting in flicker.

### SUMMARY

Methods for controlling frame contrast are provided. An exemplary embodiment of a method comprises the steps of: providing display data of the frame, wherein the display data of the frame corresponds to a plurality of pixels; obtaining a gray-level value of at least one pixel according to the display data of the frame; calculating a probability function of at least one gray-level value in a predetermined range; and determining adjustment of the at least one gray-level value in the predetermined range according to the probability function.

Devices for controlling the contrast of a frame are provided. An exemplary embodiment of a device comprises a calculation and analysis unit and an adjustment unit. The calculation and analysis unit receives display data of the frame. The display data of the frame corresponds to a plurality of pixels. The calculation and analysis unit calculates the number of pixels belonging to at least one gray-level value according to the display data of the frame and determines a predetermined range between first and second gray-level values. The adjustment unit is coupled to the calculation and analysis unit and calculates a probability function of the at least one gray-level value. The adjustment unit determines adjustment of the at least one gray-level value in the predetermined range according to the probability function in the predetermined range.

### DESCRIPTION OF THE DRAWINGS

Methods and devices for controlling the contrast of an image will become more fully understood from the detailed description given hereinbelow and the accompanying drawings, given by way of illustration only and thus not intended to be limitative of the invention.

FIG. 1 shows a transfer curve with a slope equal to 1.

FIG. 2 shows a transfer curve with a slope larger than 1.

FIG. 3 shows a transfer curve with a slope smaller than 1.

FIG. 4 shows an embodiment of a device for controlling the contrast of an image.

FIG. 5 is a histogram of the number of pixels belonging to each gray-level value.

FIG. 6 is a histogram of the number of pixels belonging to each gray-level value, calculated by logarithmic transformation.

FIG. 7 shows an embodiment of a transfer curve.

FIG. 8 is a follow chart of an embodiment of a method for controlling the contrast of an image.

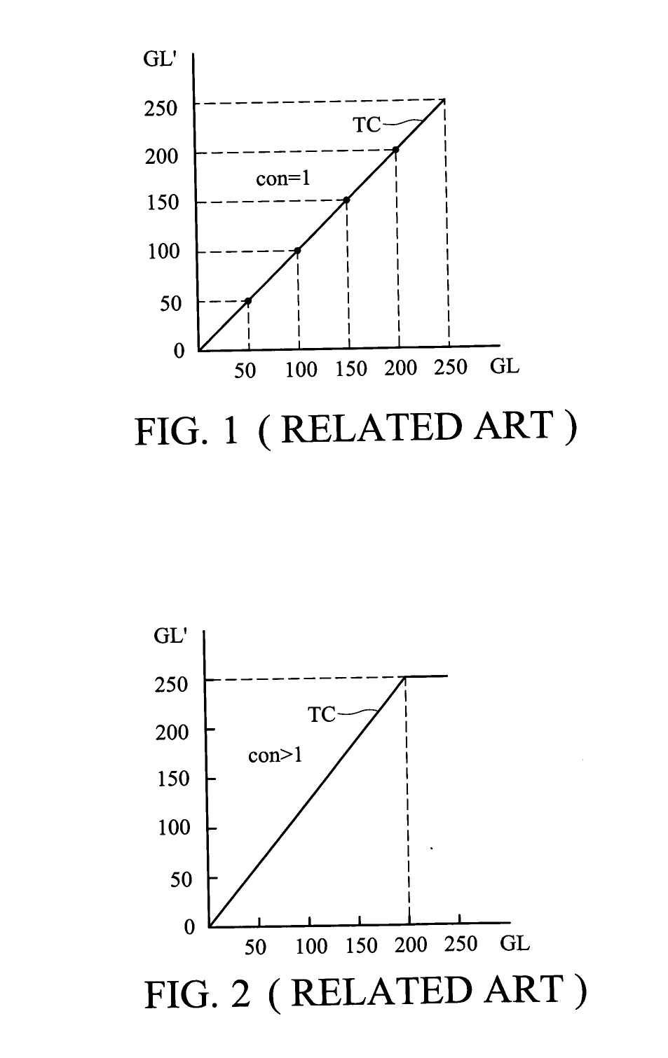

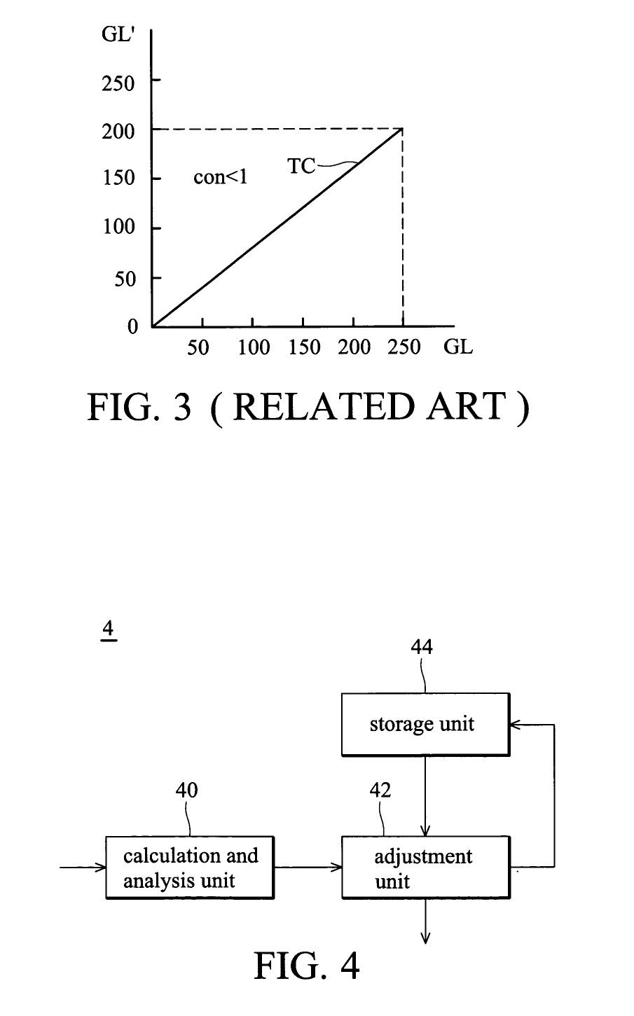

### DETAILED DESCRIPTION

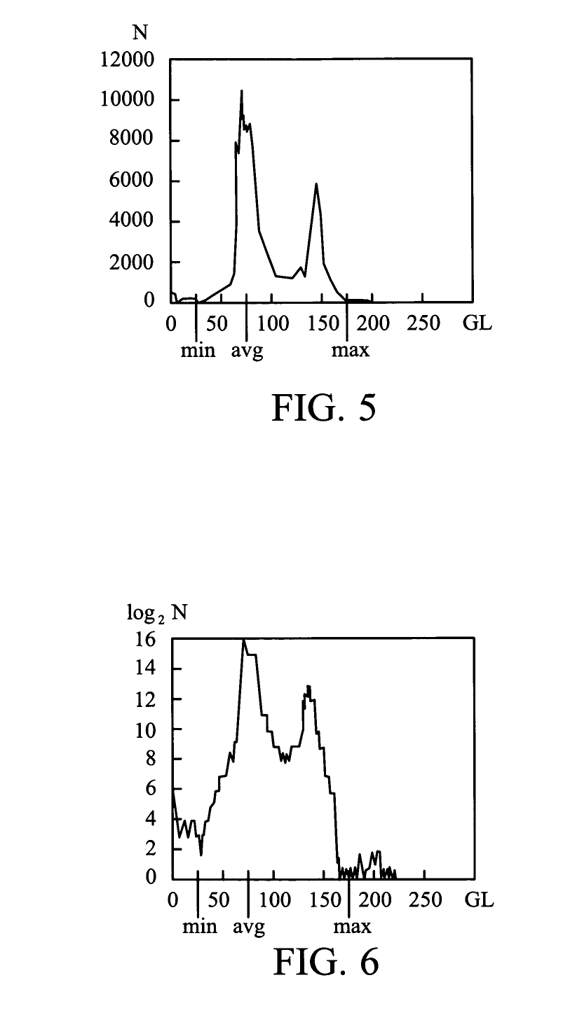

Devices for controlling the contrast of an image are provided. In some embodiments, as shown in FIG. 4, the device 4 is applied in a display device and comprises a calculation and analysis unit 40, an adjustment unit 42, and a storage unit 44. The calculation and analysis unit 40 receives display data of a frame Fₙ of an image. The display data of a frame Fₙ corresponds to a predetermined number of pixels. According to the display data of the frame Fₙ, the calculation and analysis unit 40 detects an original gray-level value of each pixel and calculates the number of pixels belonging to each original gray-level value. Referring to FIG. 5, the x-coordinate represents the original gray-level values (GL) “0” to “255”, the y-coordinate represents the number (N) of pixels belonging to each original gray-level value. According to FIG. 5, the distribution of the original gray-level values of the frame Fₙ can be determined.

The calculation and analysis unit 40 determines gray-level values min and max, gray-level values min and avg, or gray-level values min, avg and max of the frame Fₙ, according to the number of pixels belonging to each original gray-level value. Referring to FIG. 5, the gray-level value min is defined by the corresponding gray-level value that the accumulative number of pixels belonging to the original gray-level values “0” to “the corresponding gray-level value” is equal to 1 percent of the predetermined number. The gray-level value max is defined by the corresponding gray-level value that the accumulative number of pixels belonging to the original gray-level values “0” to “the corresponding gray-level value” is equal to 99 percent of the predetermined number. The gray-level value avg is an average of the original gray-level value corresponding to all pixels, as following equation:

$$a = \frac{Σ N \times GL}{S}$$

wherein, α represents the gray-level value avg, N represents the number of pixels belonging to each original gray-level value, GL represents each original gray-level value, and S represents the predetermined number.

The adjustment unit 42 is coupled to the calculation and analysis unit 40, receives the number of pixels belonging to each original gray-level value from the calculation and analysis unit 40 and implements a numerical transformation to the number of pixels belonging to each original gray-level value, such as log₂N, as shown in FIG. 6. It is assumed that the calculation and analysis unit 40 determines gray-level values min and max. The adjustment unit 42 calculates the probability function of each original gray-level value and then calculates the probability function of each original gray-level value between the gray-level values min and max, according to the logarithm of the number of pixels. The adjustment unit 42 adjusts a transfer curve between the gray-level values min and max according to the probability function. Transfer curve of the original gray-level values, being lower than the gray-level value min and higher than the gray-level value max, has slope equal to 1. Further, the adjustment unit 42 adjusts the transfer curve between the gray-level values min and max according to the following equation:
min+pf1(GL)×(max−min)
wherein, pf1(GL) represents the probability function of each original gray-level value between the gray-level values min and max.

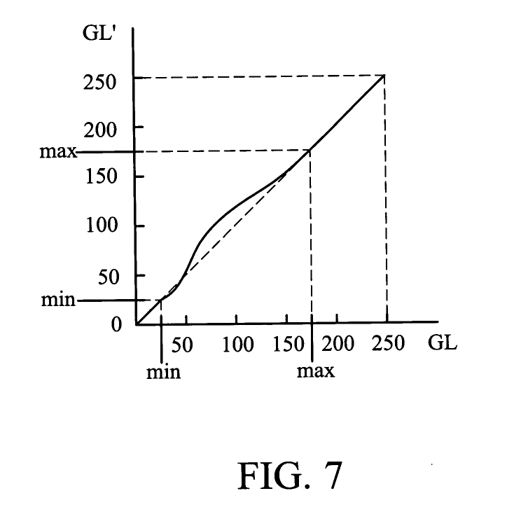

Accordingly, the adjustment unit 42 obtains a transfer curve TCₙ of the frame Fₙ, as shown in FIG. 7. In FIG. 7, the x-coordinate represents the original gray-level values GL of the frame Fₙ, the y-coordinate represents the transferred gray-level values GL′. According to the transfer curve TCₙ, the original gray-level values between “0” and min and between max to “255” are both transferred through a transfer curve whose slopeis 1. The original gray-level values between min and max are transferred through a transfer curve with a slope that is not a constant.

It is assumed that the calculation and analysis unit 40 determines gray-level values min, avg, and max. The adjustment unit 42 calculates the probability function of each original gray-level value between the gray-level values min and avg, and between the gray-level values avg and max, according to the logarithm of the number of pixels. The adjustment unit 42 transfers the original gray-level values between “0” and min and between max and “255” through a transfer curve whose slopeis 1. The adjustment unit 42 adjusts the transfer curve between the gray-level values min and avg according to the following equation:
min+pf2(GL)×(avg−min)
wherein, pf2(GL) represents the probability function of each original gray-level value between the gray-level values min and avg.

The adjustment unit 42 adjusts the transfer curve between the gray-level values avg and max according to the following equation:
avg+pf3(GL)×(max−avg)
wherein, pf3(GL) represents the probability function of each original gray-level value between the gray-level values avg and max.

Thus, the adjustment unit 42 obtains a transfer curve TCₙ of the frame Fₙ according to the probability functions and thus transfers the original gray-level values GL.

In some embodiments, the contrast of the former frame can be considered in order to decrease brightness difference between two continuous frames. Referring to FIG. 4, the storage unit 44 stores a transfer curve TC′ₙ₋₁ of a former frame Fₙ₋₁. After obtaining the transfer curve TCₙ of the frame Fₙ, the adjustment unit 42 calculates a transfer curve TC′ₙ by weighting the transfer curves TC′ₙ₋₁ and TCₙ with a constant proportion, as shown in following equation:
TC′ₙ=P×TCₙ+(1−P)×TC′ₙ₋₁, 0≦P≦1

The adjustment unit 42 transfers the original gray-level values GL to new gray-level values GL′ through the transfer curve TC′ₙ. The display device displays the frame Fₙ according to the transferred gray-level values GL′.

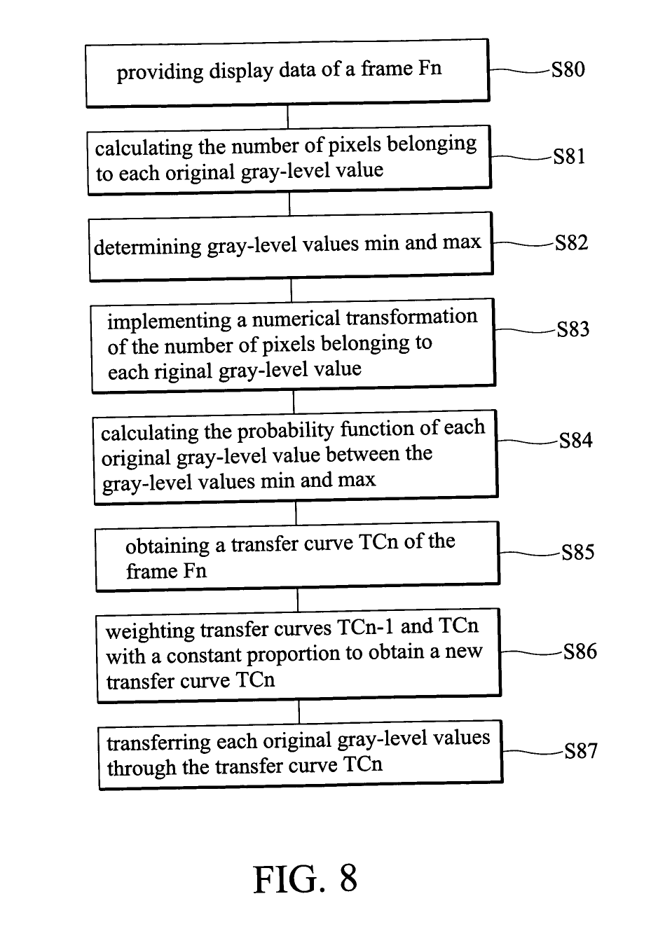

An exemplary embodiment of a method for controlling the contrast of an image is shown in FIG. 8. The method is implemented for an image of a display device. Referring to FIGS. 4 and 8, display data of a frame Fₙ of an image is provided to a calculation and analysis unit 40 (step S80), wherein the display data of the image Fₙ corresponds to a predetermined number of pixels. The calculation and analysis unit 40 detects an original gray-level value of each pixel and calculates the number of pixels belonging to each original gray-level value (step S81). The calculation and analysis unit 40 determines gray-level values min and max, gray-level values min and avg, or gray-level values min, avg and max of the frame Fₙ according to the number of pixels belonging to each original gray-level value (step S82). In this embodiment, the calculation and analysis unit 40 determines the gray-level values min and max.

The adjustment unit 42 implements a numerical transformation of the number of pixels belonging to each original gray-level value (step S83), such as log₂N. The adjustment unit 42 calculates the probability function of each original gray-level value and then calculates the probability function of each original gray-level value between the gray-level values min and max, according to the logarithm of the number of pixels (step S84). The adjustment unit 42 adjusts a transfer curve between the gray-level values min and max according to the probability function to obtain a transfer curve TCₙ of the frame Fₙ (step S85). After obtaining the transfer curve TCₙ of the former frame Fₙ, the adjustment unit 42 weights a transfer curve TC′ₙ₋₁ of a former frame Fₙ₋₁ and the transfer curve TCₙ of the frame Fₙ with a constant proportion to obtain a new transfer curve TC′ₙ of the frame Fₙ (step 86). The adjustment unit 42 transfers the original gray-level values GL to new gray-level values GL′ through the transfer curve TC′ₙ (step S87). The display device displays the frame Fₙ according to the transferred gray-level values GL′.

In some embodiments, methods for controlling the contrast of an image further comprise a storage unit 44 storing the transfer curve TC′ₙ of the frame Fₙ.

In some embodiments of devices and methods for controlling the contrast of an image, the distribution of the gray-level values is analyzed first, and then the degree of adjustment of each gray-level value is determined. Thus, the contrast of the image can be increased dynamically, preventing continuous frames of the image from flicker.

In some embodiments of devices and methods for controlling image contrast, the gray-level values min and max are determined without limitation according to system requirements. For example, when the accumulative number of pixels for the gray-level value min is equal to 0 percent of the predetermined number, the accumulative number of pixels for the gray-level value max is equal to 95 percent of the predetermined number. When the accumulative number of pixels for the gray-level value min is equal to 5 percent of the predetermined number, the accumulative number of pixels for the gray-level value max is equal to 100 percent of the predetermined number.

In some embodiments of devices and methods for controlling image contrast, the number of pixels belonging to each original gray-level value may be calculated by logarithm with other base, such as log₃N or ln(N). In some embodiments, the number of pixels belonging to each original gray-level value is calculated in numerical transformation by offset, such as log2N+S, wherein, S represents positive or negative offset. In some embodiments, the number of pixels belonging to each original gray-level value is calculated in numerical transformation with mth power, such as N^{m}, wherein m is preferably a positive lower than 1. The numerical transformation of the number of pixels belonging to each original gray-level value is determined according to system requirements, without limitation.

In some embodiments, the adjustment unit 42 can only calculate the probability function of each original gray-level value between the gray-level values min and max and omits calculation of the probability function of each original gray-level value.

In some embodiments, the adjustment unit 42 can calculate the probability function of each original gray-level value between the gray-level values min and max directly according to the number of pixels. That is, the adjustment unit 42 omits to implement a numerical transformation of the number of pixels.

In some embodiments, the calculation and analysis unit 40 can implement numerical transformation to the number of pixels first and then determine the gray-level values min and max, the gray-level values min and avg, or the gray-level values min, avg and max according to the transferred number of pixels. The gray-level value avg can be calculated by following equation:

$$a = \frac{{Σlog}_{2} ( N ) \times GL}{{log}_{2} S}$$

wherein, α represents the gray-level value avg, N represents the number of pixels belonging to each original gray-level value, GL represents each original gray-level value, and S represents the predetermined number.

In some embodiments, the storage unit 44 further stores the transfer curve TCₙ. The adjustment unit 42 weights the transfer curve TCₙ of the frame Fₙ and the transfer curve TCₙ₊₁ of the next frame Fₙ₊₁ with a constant proportion to obtain a new transfer curve TC′ₙ₊₁ of a next frame Fₙ₊₁, as represented by following equation:
TC′ₙ₊₁=Q×TCₙ₊₁+(1−Q)×TCₙ, 0≦Q≦1

Note that some embodiments of devices and methods for controlling image contrast can be applied in a single static image for enhancing the quality thereof.

While the invention has been described in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A method for controlling frame contrast comprising:
providing display data of the frame, wherein the display data of the frame corresponds to a plurality of pixels;
obtaining a gray-level value of at least one pixel according to the display data of the frame;
calculating a probability function of at least one gray-level value in a predetermined range; and
determining adjustment of the at least one gray-level value in the predetermined range according to the probability function.

2. The method as claimed in claim 1, wherein the calculation of the probability function comprising:
calculating the number of pixels belonging to the at least one gray-level value in the predetermined range; and
calculating the probability function of the at least one gray-level value in the predetermined range according to the number of pixels belonging to the at least one gray-level value in the predetermined range.

3. The method as claimed in claim 1, wherein the calculation of the probability function comprising:
calculating the number of pixels belonging to the at least one gray-level value in the predetermined range;
implementing a numerical transformation to the number of pixels belonging to the at least one gray-level value in the predetermined range; and
calculating the probability function of the at least one gray-level value in the predetermined range according to the transferred number of pixels belonging to the at least one gray-level value in the predetermined range.

4. The method as claimed in claim 3, wherein the predetermined range is between a first gray-level value and a second gray-level value.

5. The method as claimed in claim 4, wherein the first gray-level value is defined by a corresponding gray-level value whose accumulative number of pixels belonging to the gray-level values from 0 to the corresponding gray-level value is equal to a ratio of total number of pixels of the frame or a corresponding gray-level value whose accumulative numerical transformation number of pixels belonging to the gray-level values from 0 to the corresponding gray-level value is equal to a ratio of total numerical transformation number of pixels of the frame.

6. The method as claimed in claim 4, wherein when the first gray-level value is not the smallest or the largest gray-level value of the frame.

7. The method as claimed in claim 4, wherein the first gray-level value is an average gray-level value of the frame or an average numerical transfer value of the frame.

8. The method as claimed in claim 1 further comprising:
obtaining a transfer curve of the frame according to the probability function; and
adjusting the gray-level values of the pixels according to the transfer curve.

9. The method as claimed in claim 8, wherein the predetermined range is between a first gray-level value and a second gray-level value;
wherein when the first gray-level value is not the smallest or the largest gray-level value of the frame.

10. The method as claimed in claim 1 further comprising:
obtaining a first transfer curve of the frame according to the probability function;
obtaining a second transfer curve of the frame according to the first transfer curve of the frame and a first transfer curve of a former frame; and
adjusting the gray-level values of the pixels according to the second transfer curve.

11. The method as claimed in claim 1 further comprising:
obtaining a first transfer curve of the frame according to the probability function;
obtaining a second transfer curve of the frame according to the first transfer curve of the frame and a second transfer curve of a former frame; and
adjusting the gray-level values of the pixels according to the second transfer curve.

12. A method for controlling the contrast of a frame comprising:
providing display data of the frame, wherein the display data of the frame corresponds to a plurality of pixels;
calculating the number of pixels belonging to at least one gray-level value;
calculating a probability function of the at least one gray-level value; and
determining adjustment of the at least one gray-level value according to the probability function in a predetermined range.

13. The method as claimed in claim 12, wherein the predetermined range is between a first gray-level value and a second gray-level value;
wherein when the first gray-level value is not the smallest or the largest gray-level value of the frame.

14. The method as claimed in claim 12 further comprising:
obtaining a transfer curve of the frame according to the probability function; and
adjusting the gray-level values of the pixels according to the transfer curve.

15. The method as claimed in claim 12 further comprising:
obtaining a first transfer curve of the frame according to the probability function;
obtaining a second transfer curve of the frame according to the first transfer curve of the frame and a first transfer curve of a former frame; and
adjusting the gray-level values of the pixels according to the second transfer curve.

16. The method as claimed in claim 12 further comprising:
obtaining a first transfer curve of the frame according to the probability function;
obtaining a second transfer curve of the frame according to the first transfer curve of the frame and a second transfer curve of a former frame; and
adjusting the gray-level values of the pixels according to the second transfer curve.

17. A device for controlling the contrast of a frame comprising:
a calculation and analysis unit receiving display data of the frame, calculating the number of pixels belonging to at least one gray-level value according to the display data of the frame, and determining a predetermined range between a first and second gray-level value, wherein the display data of the frame corresponds to a plurality of pixels; and
an adjustment unit coupled to the calculation and analysis unit and calculating a probability function of the at least one gray-level value;
wherein the adjustment unit determines adjustment of the at least one gray-level value in the predetermined range according to the probability functionin the predetermined range.

18. The device as claimed in claim 17, wherein when the first gray-level value is not the smallest or the largest gray-level value of the frame.

19. The device as claimed in claim 17 further comprising:
a storage unit coupled to the adjustment unit and storing a first transfer curve of a former frame, wherein the adjustment unit generates a second transfer curve according to the first transfer curve of the former frame former for the adjustment unit.

20. The device as claimed in claim 17 wherein the calculation and analysis unit further implements a numerical transformation to the number of pixels belonging to the at least one gray-level value.
